(19) United States
(12) Patent Application Publication
(10) Pub. No.: US 2012/0144895 A1
(43) Pub. Date: Jun. 14, 2012

(54) DEVICE FOR DETECTING AT LEAST ONE ZERO POSITION

(75) Inventors: Oliver Maschmann, Immenstaad (DE); Andreas Fuessl, Kressbronn (DE)

(73) Assignee: ZF FRIEDRICHSHAFEN AG, Friedrichshafen (DE)

(21) Appl. No.: 13/391,396

(22) PCT Filed: Aug. 11, 2010
(86) PCT No.: PCT/EP2010/061670

§ 371 Date: Feb. 21, 2012

(30) Foreign Application Priority Data
Aug. 25, 2009 (DE) 10 2009 028 859.7

(51) Int. Cl. G01B 21/16

(52) U.S. Cl. 73/1.79

(57) ABSTRACT

A device for detecting at least the zero-point position of at least one moving component. The device comprises at least one detection device that is fixedly supported relative to the zero-point position of the component. The component has at least one recess in the area of the zero-point position to be detected. The detection device has at least first and second sensors which form a sensor pair. The sensor pair is associated with the recess, in the area of the zero-point position, in order to detect a change of state so that the zero-point position can be detected without moving the component.

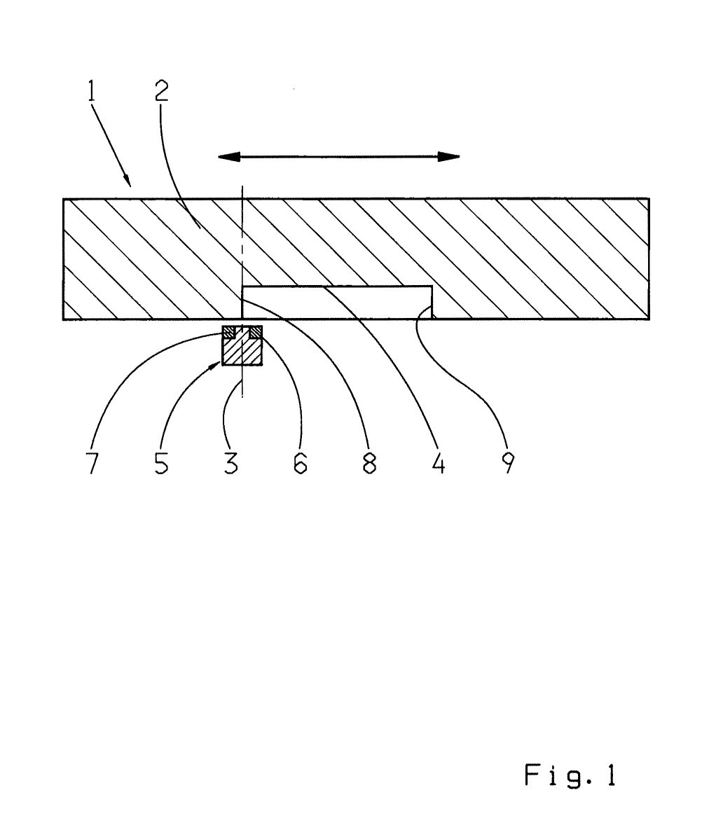

This application is a national stage completion of PCT/EP2010/061670 filed Aug. 11, 2010 which claims priority from German Application No. 10 2009 028 859.7 filed August 25, 2009.

### FIELD OF THE INVENTION

The present invention concerns a device for detecting at least one zero position of at least one moving component.

### BACKGROUND OF THE INVENTION

For the detection of positions, for example in the case of adjustment drive mechanisms, an electric sensor system is usually used. For example, the sensors used can operate on the basis of an active or even a passive inductive process. For reasons of cost and robustness, positions are not detected continuously, so a switching sensor system is used. In a switching sensor system, the sensor changes between two electrically distinct states.

For example, from the document DE 10 2007 043 589 A1 a device for determining a neutral position of two components is known, the two components being arranged so as to move in the longitudinal direction relative to one another. The device comprises displacement means for moving the components to any desired relative position and a position sensor for detecting the relative movement, with displacement path markings on the first component and a marking sensor on the second component, which recognizes the path markings within a detection range. In this case the neutral position or zero-point position corresponds to the position of the components around which they move uniformly during operation. Each time the device is brought into operation, no neutral position has yet been determined, in other words, although the previously determined distance between the detection range of the marking sensor and the path markings is known, the position adopted at the time by the components relative to one another where their neutral position in located, is unknown. Accordingly it is necessary for the displacement means to move the components relative to one another in such manner that the path markings pass across the marking sensor, so the movement direction depends on the marking range recognized within the detection range.

Consequently, with the known device it is unconditionally necessary, when operation begins, to move the components in order to be able to detect the position or zero-point position.

### SUMMARY OF THE INVENTION

The purpose of the present invention is to propose a device for detecting at least one reference position or zero-point position, of the type described at the start, by means of which the zero-point position can be detected without any prior movement.

Accordingly, a device is proposed for detecting at least one zero-point position as a reference position of at least one moving component or the like, the device comprising at least one positionally fixed detection device associated with the zero-point position of the component and having at least one recess in the component in the area of the zero-point position to be detected, such that as the detection device at least two sensors forming a sensor pair or the like are provided, and such that the sensors are associated with the recess in the area of the zero-point position in order to detect a change of state, so that the zero-point position can be detected without any movement of the component.

The distinguishing feature of the sensors used for the sensor pair is that at a defined position they undergo a change of state by switching. In this way, at the moment when the system is switched on, by virtue of the respective levels of the two sensors it can be determined clearly which state each is in. Advantageously, because of this an otherwise necessary initialization process is not needed. Moreover, no active movements of the displacement mechanism or of the component are needed in order to detect the zero-point position. This minimizes the energy needs of the device according to the invention. Especially when the device is used in safety systems, a further advantage is obtained in that after starting, such systems can remain mechanically locked since no movement is required for the detection process. Thus, the requirement for no movement from a rest position is fulfilled.

Accordingly, the device proposed according to the invention enables absolute-position referencing by the use of redundant sensor systems which, by virtue of their particular arrangement for detecting changes of state, make it possible to detect absolute positions.

In a possible embodiment variant of the invention it can be provided that the sensors of the sensor pair are located each on one side of an end area or suchlike of the recess for detecting the state transition, the end area corresponding to the zero-point position of the component.

In this way it is possible, for example after bringing the device into operation without any prior movement of the component, for the zero-point position to be recognized clearly if the two sensors are in different states. In that the zero-point position of the component is, for example, associated with an end area of the recess, one sensor does not detect any component material because it is still in the area of the recess while the other sensor does detect component material since it is on the other side of the end area, i.e. it is located over the component. In such a case the component can be recognized as being at its zero-point position with complete certainty, so that normal operation can begin.

If after the start of operation both sensors detect the same state, it can be concluded that the component is not at its zero-point position. In such a situation a corresponding movement of the component to its neutral position is needed in order to eliminate the defect condition recognized.

Preferably, the device according to the invention can be used to detect the zero-point position of components of an adjustment drive mechanism or the like, for example to detect a wheel position in the case of a vehicle steering system or even to detect positions of robotic drive mechanisms or suchlike.

As sensors, it is preferable to use switching sensors which only recognize two states so that they can detect a position unambiguously. If the sensors are used to determine a reference position, then so-termed proximity sensors can also be used. With switching sensors, the sensors change between two states that can be distinguished electrically with certainty. Other types of sensors as well could be used.

### BRIEF DESCRIPTION OF THE DRAWING

The present invention will now be explained in more detail with reference to the drawing. The single FIGURE illustrating the invention shows schematically a possible structure of a device 1 according to the invention for detecting a zero-point position of a moving component 2. As the component, for example a component of an adjustment drive mechanism or the like can be considered.

### DETAILED DESCRIPTION OF THE DRAWING

The component 2 can move both ways in the longitudinal direction, as indicated by the double arrow in the FIGURE. The zero-point position 3 of the component 2, determined by its design, is indicated by a dot-dash line. Moreover, the component 2 has a recess 4 with two ends or end areas 8 and 9. The recess is associated with the zero-point position 3 at one of its end areas.

In addition, the device 1 comprises a positionally fixed detection device 5 associated with the zero-point position 3 of the component 2. The detection device 5 consists essentially of two sensors 6, 7 which form a sensor pair. The sensors 6, 7 are arranged on the two sides of the zero-point position 3 of the component 2 determined by design, namely the end 8 of the recess 4, and are positioned a small distance apart from one another. The distinguishing feature of the sensors 6, 7 is that at a defined position they can undergo a state transition by switching in a corresponding manner. The switching sensors 6, 7 can switch between two states that can be distinguished electrically in an unambiguous way, so that they can be used for a clear position determination.

According to the invention, the recess 4 with its end area is associated with the zero-point position 3 of the component 2 in such manner that in this way, in the area of the zero-point position 3, a change of state can be recognized by the sensors 6, 7. For example if after operation begins the two sensors different states, then the zero-point position 3 of the component 2 can be recognized. This is because the sensor 6 on the right of the detection device 5 is not associated with any material and therefore detects a corresponding state, since the sensor 6 is over the recess 4. In contrast, the sensor 7 on the left is over the material of the component 2 since, as shown in the FIGURE, it is not above the recess 4. In this way the different states that characterize the zero-point position 3 of the component 2 can be recognized.

For example, if the component 2 is not at its zero-point position 3 the detection device with the two sensors 6, 7 is over the component 2 either within the recess 4 or outside the recess 4. In this situation both sensors 6, 7 detect the same states, since the sensors 6, 7 are both either over material or over the recess 4. Thus, the detection device can determine that the component 2 is not at its zero-point position 3 and can initiate appropriate measures to correct this defective condition. The length of the recess 4 is chosen such that during the movement of the component 2 it cannot reach the other end area 9 of the recess 4, i.e. the one not associated with the zero-point position 3.

### INDEXES

1 Device
2 Component
3 Zero-point position
4 Recess
5 Detection device
6 Right-hand sensor
7 Left-hand sensor
8 Left-hand end area of the recess
9 Right-hand end area of the recess

1-8. (canceled)

9. A device (1) for detecting at least one zero-point position (3) of at least one moving component (2), the device comprising:
at least one positionally fixed detection device (5) associated with the zero-point position (3) of the component (2);
at least one recess (4) being formed in the component (2) in an area of the zero-point position (3) to be detected;
the detection device (5) comprising at least first and second sensors (6, 7) that form a sensor pair; and
the sensor pair being associated with the recess (4), in the area of the zero-point position (3), in order to detect a change in state such that the zero-point position (3) is detectable without moving the component (2).

10. The device according to claim 9, wherein the at least first and second sensors (6, 7) of the sensor pair are each positioned on a respective side of an end area (8, 9) of the recess (4) in order to detect a transition state, and the end area (8) corresponds to the zero-point position (3) of the component (2).

11. The device according claim 9, wherein when the detection device begins operating and the at least first and second sensors (6, 7) determine different states, then the zero-point position (3) of the component (2) is detected.

12. The device according to claim 9, wherein when the detection device begins operating and the first and second sensors (6, 7) determine a same state, then a position of the component (2), other than the its zero-point position (3), is detected.

13. The device according to claim 9, wherein the device detects the zero-point position (3) of a component (2) of an adjustment drive mechanism.

14. The device according to claim 9, wherein the device detects the zero-point wheel position of a vehicle steering system.

15. The device according to claim 9, wherein the device is incorporated into a robot drive mechanism for detecting the zero-point position (3) of the robot drive mechanism.

16. The device according to claim 9, wherein the first and second sensors (6, 7) that form a sensor pair comprises first and second switching sensors for detection of two states.

17. A device (1) for detecting a zero-point position (3) of a moving component (2), the device comprising:
at least one detection device (5) that is support at a fixed position;
the at least one moving component (2) being movable with respect to the at least one detection device (5),
the at least one moving component (2) comprising a recess (4) having first and second spaced apart ends (8, 9), and at least the first end (8) defining an axis that extends normally to the at least one moving component (2);
the detection device (5) comprising first and second sensors (6, 7), and each of the first and the second sensors (6, 7) being switchable between two states;
when the at least one moving component (2) is in the zero-point position (3), the at least one detection device (5) being aligned with the axis extending normal to the at least one moving component (2) such that the first and the second sensors (6, 7) are located on opposite sides of the axis and the first and the second sensors (6, 7) are in different states, and
when the at least one moving component (2) is moved from the zero-point position (3), the first and the second sensors (6, 7) are located on a same side of the axis and the first and the second sensors (6, 7) are in a same state.

18. The device according to claim 17, wherein when the detection device begins operating and the at least first and second sensors (6, 7) determine different states, then the zero-point position (3) of the component (2) is detected.

19. The device according to claim 17, wherein when the detection device begins operating and the first and second sensors (6, 7) determine a same state, then a position of the component (2), other than the its zero-point position (3), is detected.
